(19) United States
(12) Patent Application Publication
(10) Pub. No.: US 2013/0170924 A1
(43) Pub. Date: Jul. 4, 2013

(54) Direct Tension Indicating Washer With Centering Elements

(71) Applicants: Ivan Wayne Wallace, Walpole, NH (US); Jordan Richardson, Walpole, NH (US)

(72) Inventors: Ivan Wayne Wallace, Walpole, NH (US); Jordan Richardson, Walpole, NH (US)

(73) Assignee: APPLIED BOLTING TECHNOLOGY PRODUCTS, INC., Bellow Falls, VT (US)

(21) Appl. No.: 13/343,040

(22) Filed: Jan. 4, 2012

(51) Int. Cl. F16B 43/00

(52) U.S. Cl. 411/531

(57) ABSTRACT

A direct tension indicating washer includes a body having a first surface having a protuberance formed thereon; the body having a second surface having an indentation formed opposite the protuberance; a plurality of centering elements positioned at an inner diameter of the body, the centering elements extending radially inwardly from the inner diameter of the body.

### BACKGROUND

The invention relates in general to direct tension indicating washers and in particular to direct tension indicating washers including centering elements for keeping the direct tension indicating washer centered about the shank diameter of a fastener.

Direct tension indicating (DTI) washers are used in the art to indicate when proper bolt tension has been reached. U.S. Pat. No. 5,931,618, the entire contents of which are incorporated herein by reference, discloses an exemplary DTI. FIG. 1 is a top view of the DTI from U.S. Pat. No. 5,931,618. A direct tension indicating washer 60 includes protuberances 12 formed on a first surface 14 and corresponding indentations 16 formed on a second surface 18 opposite the protuberances 12. The direct tension indicating washer 60 also includes channels 62 that lead from each indentation 16 to the outer diameter of the direct tension indicating washer 60. The indentation 16 is filled with an indicating material 64. The direct tension indicating washer 60 is manufactured using a tool and die to stamp the protuberances 12, indentations 16 and channels 62 into a blank washer. Other processes, such as metal machining, electronic printing, or metal casting may be used to form the direct tension indicating washer 60. Direct tension indicating washer 60 is made from carbon steel, but stainless steel, nonferrous metals, and other alloy products may also be used. The indicating material 64 is an extrudable, elastomeric solid material such as colored silicone. FIG. 2 is a cross-sectional view taken along line 2-2 of FIG. 1.

While the direct tension indicating washer of FIGS. 1-2 is well suited for its intended purposes, there is a need for improved centering on the bolt shank diameter. As a direct tension indicating washer is fit within a bolt assembly, there are multiple mechanical tolerances that can combine to inhibit the effective performance of a direct tension indicating washer. The performance instability is apparent by non-uniform compression of the protrusions due to eccentricity of the assembly parts around the bolt. This leads to uneven “squirt” when used with direct tension indicating washers that emit an indicating material. For direct tension indicating washers lacking an indicating material, the lack of centering leads to irregular feeler gauge refusals.

### SUMMARY

Embodiments of the invention include a direct tension indicating washer having a body having a first surface having a protuberance formed thereon; the body having a second surface having an indentation formed opposite the protuberance; and a plurality of centering elements positioned at an inner diameter of the body, the centering elements extending radially inwardly from the inner diameter of the body.

### BRIEF DESCRIPTION OF THE DRAWINGS

Referring now to the drawings wherein like elements are numbered alike in the several Figures:

FIG. 1 is a top view of a conventional direct tension indicating washer;

FIG. 2 is a cross-sectional view of the direct tension indicating washer shown in FIG. 1 taken along line 2-2;

FIG. 3 is a top view of a direct tension indicating washer in exemplary embodiments;

FIG. 4 depicts a cross-section of the direct tension indicating washer of FIG. 3 with a bolt; and

FIG. 5 is a top view of a direct tension indicating washer in alternate embodiments.

### DETAILED DESCRIPTION

Embodiments of the invention related to a direct tension indicating washer. An alignment system to center the direct tension indicating washer on the bolt while not inhibiting the performance of the DTI can be accomplished by frangible centering elements on the ID of the direct tension indicating washer to engage the bolt and provide centering. The frangible centering elements are constructed to engage the threads of the bolt or be pressed onto the bolt. When the bolt starts to be tensioned, the centering elements experience shear and do not influence the compressive force represented by the plastic deformation of the direct tension indicating washer protuberances.

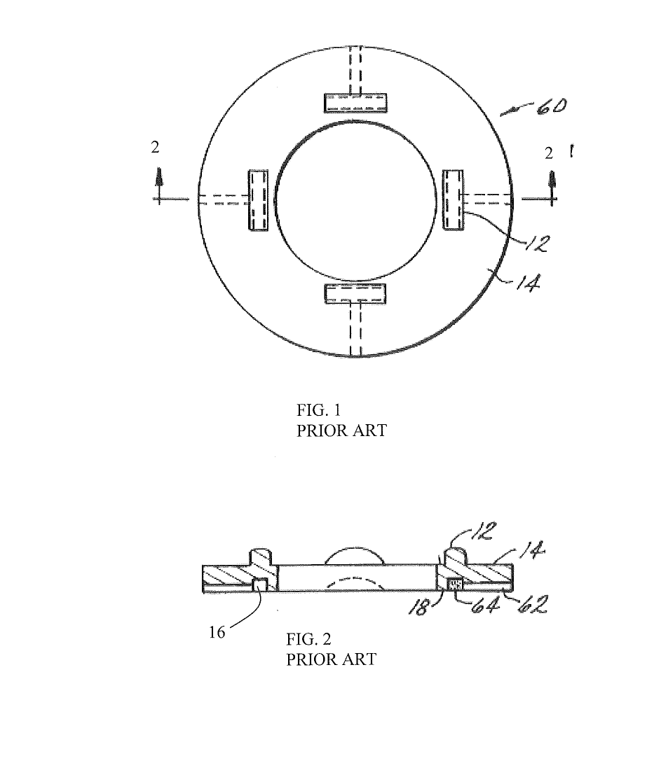

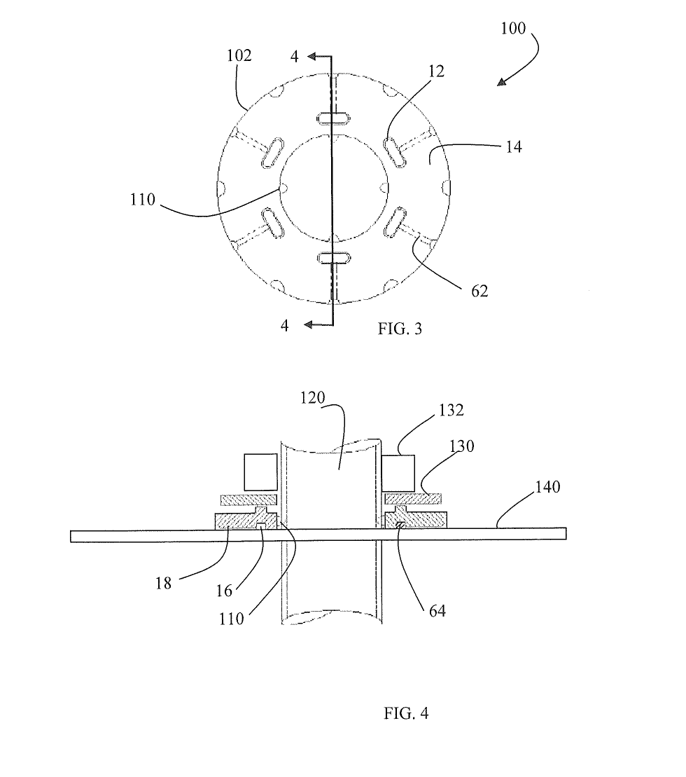

FIG. 3 is a top view of a direct tension indicating washer 100 in exemplary embodiments. The direct tension indicating washer 100 is similar in construction to the direct tension indicating washer 60 of FIG. 1. Direct tension indicating washer 100 includes a body 102 having protuberances 12 formed on a first surface 14 and corresponding indentations 16 formed on a second surface 18 opposite the protuberances 12 (FIG. 4). The direct tension indicating washer 100 also includes channels 62 that lead from each indentation 16 to the outer diameter of the direct tension indicating washer 100. The indentation 16 is filled with an indicating material 64. The indicating material 64 is an extrudable, elastomeric solid material such as colored silicone. Direct tension indicating washer 100 may include features from U.S. Pat. No. 6,425,718, U.S. Patent Application Application Publication 20080138167, U.S. Pat. No. 7,857,562 and U.S. Patent Application Publication 20110123288, the entire contents of all these publications are incorporated herein by reference.

Also shown in FIG. 3 are centering elements 110 that serve to center the direct tension indicating washer 100 about a fastener (e.g. a bolt) passing through the ID of the direct tension indicating washer 100. The centering elements 110 extending radially inwardly from the inner diameter of the body. If a bolt has a shaft that is out-of-round, centering elements 110 accommodate the bolt by compressing, bending or snapping to keep the bolt centered in the direct tension indicating washer 100. Further, if the bolt is mounted horizontally, the centering tabs maintain the direct tension indicating washer 100 centered about the bolt until the bolt is tensioned instead of allowing the direct tension indicating washer 100 to drop out of collinear alignment with the bolt.

Centering elements 110 may be formed in a variety of manners. In an exemplary embodiment, centering elements 110 are frangible tabs that bend or snap when contacted by a fastener. The tabs may be formed along with the body 102 during a stamping process, so that the tabs are integrally formed with body 110 from the same material. Alternatively, centering elements 110 may be made from a plastic and secured to the body 102 by adhesives, press fit, etc. In either case, the centering elements 110 may be sized so as to engage threads on the bolt to aid in positioning the direct tension indicating washer 100 about the bolt. In alternate embodiments, the centering elements 110 are made from globules of an adhesive such as a contact cement that remains flexible and rubbery after drying.

As shown in FIG. 3, centering elements 110 are positioned around the ID of the direct tension indicating washer 100. The centering elements 110 are preferably arranged radillay around the ID of the direct tension indicating washer 100 at equal angular spacing. As shown in FIG. 3, four centering elements are provided at 90 degree intervals about the ID of the direct tension indicating washer 100.

FIG. 4 depicts a cross-section of the direct tension indicating washer of FIG. 3 with a bolt 120 inserted through the ID of the direct tension indicating washer 100. Centering tabs 110 contact the shank of bolt 120 to keep the bolt centered in the direct tension indicating washer 100. As noted above, the centering tabs 110 may compress, bend or break to accommodate bolts that are out of specification or out of round.

A washer 130 is shown positioned adjacent protuberances 12. As nut 132 is tightened, direct tension indicating washer 100 is compressed between washer 130 and structure 140. When the calibrated bolt tension is reached, indicating material 64 forced through channels 62 appears at the outer periphery of direct tension indicating washer 100.

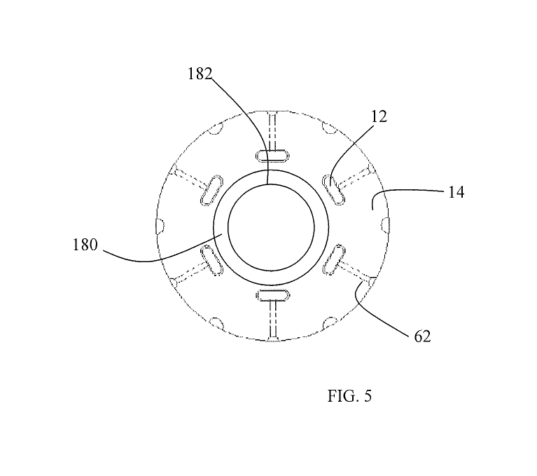

FIG. 5 depicts a direct tension indicating washer in an alternate embodiment. In this embodiment, the centering element 180 is a frangible ring having an inner diameter edge 182 for contacting a shank of a bolt. The inner diameter of the frangible ring serves as a plurality of centering elements. The frangible ring 180 can deform at one or more locations along inner edge 182 to accommodate bolt shanks that are out of round or out of tolerance. The frangible ring 180 contacts the bolt shank to seal the inner edge 182 against the bolt shank. This prevents the ingress of corrosive fluids, which is important in certain applications.

In an alternate embodiment, the centering elements may include an embedded lubricant for lubricating threads of a bolt passing through the direct tension indicating washer. The centering elements may be implemented using a plastic (e.g., nylon or polyamid) with an embedded lubricant. The centering elements are sized so as to engage the threads of a bolt. As the direct tension indicating washer is threaded onto a bolt, the threads are lubricated through frictional engagement with the centering elements.

Although the centering elements of FIGS. 3-5 are shown with a direct tension indicating washer having an indicating material and channels, it is understood that the centering elements may be used with direct tension indicating washers lacking indicating material, that is, direct tension indicating washers that use compression of protuberances 12 and a feeler gauge to detect proper bolt tension.

The centering elements provide several benefits to the manufacturer and the installer. Since the centering elements contact the bolt shank, the ID of the direct tension indicating washers can be larger, and can be manufactured with larger tolerances. This is helpful when using the direct tension indicating washers with bolts that are out of specification, out of round, or include manufacturing residuals (burrs, fins). The centering elements allow the ID of the direct tension indicating washer to be larger and still provide a centering function. The centering elements can also grip the bolt shank and hold the direct tension indicating washer to a bolt shank. This is particularly helpful when an installer is working overhead, with a bolt aligned vertically.

While preferred embodiments have been shown and described, various modifications and substitutions may be made thereto without departing from the spirit and scope of the invention. For example, the centering elements may be used with conventional, non-squirting, direct tension indicating washers. Accordingly, it is to be understood that the present invention has been described by way of illustration and not limitation.

What is claimed is:

1. A direct tension indicating washer comprising:
a body having a first surface having a protuberance formed thereon;
the body having a second surface having an indentation formed opposite the protuberance; and
a plurality of centering elements positioned at an inner diameter of the body, the centering elements extending radially inwardly from the inner diameter of the body.

2. The direct tension indicating washer of claim 1 further comprising:
an indicating material positioned in the indentation; and
a channel leading from the indentation to an outer diameter of the body.

3. The direct tension indicating washer of claim 1 wherein:
the centering elements include centering tabs.

4. The direct tension indicating washer of claim 3 wherein:
the centering tabs are integrally formed with the body.

5. The direct tension indicating washer of claim 4 wherein:
the centering tabs and the body are stamped from metal.

6. The direct tension indicating washer of claim 3 wherein:
the centering tabs are separate from and secured to the body.

7. The direct tension indicating washer of claim 6 wherein:
the centering tabs are plastic and the body is metal.

8. The direct tension indicating washer of claim 1 wherein:
the centering elements are globules of adhesive.

9. The direct tension indicating washer of claim 1 wherein:
the centering elements are positioned within the inner diameter of the body at equal angles to each other.

10. The direct tension indicating washer of claim 1 wherein:
the centering elements include a frangible ring positioned at an inner diameter of the direct tension indicating washer.

11. The direct tension indicating washer of claim 1 wherein:
the centering elements include an embedded lubricant to lubricate bolt threads.
